(19) United States
(12) Patent Application Publication
(10) Pub. No.: US 2024/0268357 A1
(43) Pub. Date: Aug. 15, 2024

(54) HOUSING SYSTEM FOR POULTRY, AND POULTRY HOUSE

(71) Applicant: BIG DUTCHMAN INTERNATIONAL GMBH, Vechta (DE)

(72) Inventors: Krste Pucoski, Neuenkirchen-Vörden (DE); Denis Skljar, Diepholz (DE)

(73) Assignee: BIG DUTCHMAN INTERNATIONAL GMBH, Vechta (DE)

(21) Appl. No.: 18/569,495

(22) PCT Filed: Mar. 10, 2023
(86) PCT No.: PCT/EP2023/056098

§ 371 Date: Dec. 12, 2023

(30) Foreign Application Priority Data
Mar. 15, 2022 (LU) LU501665

(51) Int. Cl. A01K 31/16; A01K 31/22

(52) U.S. Cl. CPC A01K 31/165; A01K 31/22

(57) ABSTRACT

A housing system for poultry, includes an animal habitation area which is divided into a first partial habitation area and a second partial habitation area by a centrally disposed row of nests, wherein the row of nests has a first nest assembly with a first egg channel and a second nest assembly with a second egg channel.

### CROSS-REFERENCE TO FOREIGN PRIORITY APPLICATION

The present application claims the benefit under 35 U.S.C. §§ 119(b), 119(e), 120, and/or 365(c) of PCT/EP2023/056098 filed Mar. 10, 2023, which claims priority to Application No. LU501665 filed Mar. 15, 2022.

### FIELD OF THE INVENTION

The invention relates to a housing system for poultry, in particular laying hens, in particular for poultry farming. A poultry house for holding poultry, in particular a house for laying hens, a method for holding poultry, in particular laying hens, as well as the use of a housing system, is also disclosed.

### BACKGROUND OF THE INVENTION

Different types and designs of housing systems for poultry, in particular laying hens, in particular for poultry farming, are known. As an example, DE 20 2007 015 498 U1 describes a housing system with a centrally disposed egg channel and nests which are accessible from alternate sides.

However, further improvements would be advantageous, in particular having regard to the wellbeing of the animal and/or a simple construction and/or better use of space.

Thus, an objective of the present invention is to provide a housing system for poultry, in particular laying hens, in particular for poultry farming. A poultry house for holding poultry, in particular a house for laying hens, a method for holding poultry, in particular laying hens, as well as the use of a housing system, are also disclosed, which are improved over existing solutions.

### SUMMARY OF THE INVENTION

In accordance with the invention, this objective is achieved by a housing system for poultry, in particular laying hens, in particular for poultry farming, comprising an animal habitation area which is divided into a first partial habitation area and a second partial habitation area by a centrally disposed row of nests, wherein the row of nests has a first nest assembly with a first egg channel and a second nest assembly with a second egg channel.

This arrangement with a centrally disposed row of nests with two nest assemblies, two egg channels, and two partial habitation areas, has a variety of advantages. Firstly, a compact structure is thereby produced in the row of nests, so that the eggs can roll off over less soiled regions and shorter roll-off distances. This leads to a better egg quality, because this way, the eggs are less soiled and less damaged, perhaps by obstacles during roll-off. In addition, this arrangement with the central row of nests with two nest assemblies and two egg channels allows for simple and improved use of the two partial habitation areas for equipment, such as feeding equipment, drinkers, and perches. Furthermore, the arrangement described herein with two separate egg channels has the advantage that in the region behind the respective nest assembly, the egg channels are accessible to poultry as a usable space, and therefore overall, the available space can be put to better use.

Advantageously, this arrangement contributes to producing efficient transport of eggs from the two nest assemblies via separate egg channels, and at the same time to finding a simple solution which improves the use of space.

Furthermore, the solution described herein is based, inter alia, on the following findings. In arrangements with a central egg channel, for example, poultry cannot access the egg channel, and therefore it cannot be used as usable space for the poultry. Furthermore, in this regard, the egg channel is also difficult to access for inspection and cleaning. In an arrangement with a lateral egg channel, on the other hand, the nest is only accessible via the egg channel. Thus, the egg channel has to be covered and the poultry can occupy the entire row of individual nests from one side over this region, which is often heavily soiled. The alternating nests described in DE 20 2007 015 498 U1 with a central egg channel suffer from the disadvantage that the space required over the width of the house is identical to the space required for an arrangement with a double nest (i.e., an arrangement with individual nests which are accessible from different sides), although in DE 20 2007 015 498 U1, a maximum of only half as much nest space is created. A large proportion of the width of the house in DE 20 2007 015 498 U1 is therefore wasted from the planning point of view for linear equipment such as feed lines or drinkers. Furthermore, here too, the entire egg channel has to be covered so that the animals can use it as a floor.

In accordance with a preferred embodiment, the first egg channel is disposed between the first nest assembly and the second partial habitation area, and/or the second egg channel is disposed between the second nest assembly and the first partial habitation area.

Thus, the egg channels are therefore located at the two edges of the row of nests where the row of nests borders the partial habitation areas.

In a further preferred embodiment, the first egg channel and the second egg channel run parallel to each other and/or parallel to the longitudinal direction of the row of nests. A further preferred development is characterized in that a cover section of the first egg channel is provided with a first cover, wherein preferably, the first cover is partly formed by the first nest assembly and partly formed by a cover floor, wherein preferably, the cover floor is configured so as to serve as a usable space for the poultry. Furthermore, advantageously, a cover section of the second egg channel is provided with a second cover, wherein preferably, the second cover is partly formed by the second nest assembly and partly formed by a cover floor, wherein preferably, the cover floor is configured so as to serve as a usable space for the poultry.

The cover sections for the egg channels preferably adjoin, are adjacent to, and/or overlap with the respective rear sides of the nest assemblies. Preferably, eggs roll out of the nest assemblies in the direction of the rear sides and from there reach the respective egg channel. To this end, the egg channels may be disposed so as to be laterally adjacent to the respective rear sides of the nest assemblies, or even be disposed so as to be below and/or inwardly offset, partly below the respective nest assembly and extending laterally outwards therefrom. Preferably, the cover floor is respectively configured in a manner such that the region of the cover section not covered by the respective nest assembly covers the respective egg channel.

A floor of the first nest assembly and/or a floor of the second nest assembly is or are preferably inclined from the access side of the respective nest assembly to a rear side of the respective nest assembly, preferably inclined downwards towards the rear side.

An inclination, in particular a uniform inclination, of the first and/or second partial habitation area in particular means that the respective partial habitation areas do not have any steps or kinks between regions with different inclinations, but rather form a continuous area in one plane which is inclined with respect to a horizontal plane. This has the advantage that eggs which are laid outside the nest in the partial habitation area can roll off without the risk of them being damaged by steps or kinks.

In accordance with a preferred embodiment, a lower section of the first egg channel runs wholly or partially below the second nest assembly, and/or a lower section of the second egg channel runs wholly or partially below the first nest assembly.

This has the advantage that no separate covers have to be provided in the lower sections of the egg channels. Moreover, this solution means that in the region of the lower sections, the available area has a twofold function, in that the lower sections are disposed below the nest assemblies, in particular in a region adjoining the access side of the respective nest assembly. Thus, these areas are available to the poultry as nesting areas and the lower sections of the egg channels below them do not take up any additional surface area. This has the advantage, inter alia, that the region of the egg channel or the egg channels which has a tendency to become soiled, which is preferably intended to be covered, is only 50% as large as that for a nest on alternate sides and a central egg channel.

In a further preferred embodiment, the first nest assembly and the second nest assembly are accessible to poultry from different, preferably opposite, access sides, wherein preferably, the access side for the first nest assembly faces the first partial habitation area and/or the access side for the second nest assembly faces the second partial habitation area.

Preferably, a rear side of the first nest assembly faces the second partial habitation area and/or adjoins the second partial habitation area. Preferably again, a rear side of the second nest assembly faces the first partial habitation area and/or adjoins the first partial habitation area.

Thus, preferably, the poultry can enter the first nest assembly from the first partial habitation area and/or the second nest assembly from the second partial habitation area. Preferably, the rear sides of the respective nest assemblies are opposite to the access sides of the respective nest assemblies.

The respective cover sections of the two egg channels preferably extend along one of the rear sides of the respective nest assembly.

More preferably, the first partial habitation area has one or more feeding devices and/or one or more drinkers and/or one or more perches. Preferably again, the second partial habitation area has one or more feeding devices and/or one or more drinkers and/or one or more perches.

In accordance with a preferred embodiment, in the longitudinal direction of the row of nests, the first nest assembly and the second nest assembly are disposed in succession and/or are separated from one another, preferably by a passageway, wherein the passageway preferably has a passageway cover, in particular a passageway cover for passageway sections of the first egg channel and/or of the second egg channel, wherein preferably, the passageway cover is configured to serve as a usable space for the poultry.

Preferably, passageway sections of the egg channels extend between the two nest assemblies and are preferably covered by a passageway cover. Preferably, the poultry from the first partial habitation area can move via the passageway into the second partial habitation area, and vice versa. More preferably, personnel can also move via the passageway from the first partial habitation area into the second partial habitation area, and vice versa.

More preferably, the first partial habitation area is inclined towards the row of nests. Yet more preferably, the second partial habitation area is inclined towards the row of nests. This is advantageous, so that eggs laid in the partial habitation areas can roll off towards the row of nests and the egg channels disposed therein.

Preferably, the egg channels with their passageway sections also run continuously through the passageway.

Particularly preferably, the first egg channel is disposed to receive eggs from the first nest assembly and/or from the second partial habitation area, preferably through an egg receiving gap. Furthermore, the first egg channel is preferably disposed below a lower end of the first partial habitation area and/or below a lower end of the second partial habitation area.

More preferably, the second egg channel is disposed to receive eggs from the second nest assembly and/or from the first partial habitation area, preferably through an egg receiving gap. Furthermore, the second egg channel is preferably disposed below a lower end of the first partial habitation area and/or below a lower end of the second partial habitation area.

These embodiments have the advantage that eggs which have not been laid in the nest, but rather in the region in front of a nest entrance or in other regions of the partial habitation areas (what are known as “system eggs”), no longer have to roll through a nest onto the egg belt, but can roll directly from the partial habitation area onto the egg belt adjoining this partial habitation area. Obtaining (mostly undamaged) system eggs in this manner increases the general productivity in the house. Even in the case of an embodiment with closed nests, the system eggs can still roll onto the egg belt independently of the configuration of the nest with or without an ejection system, for example as a tilting floor nest or ejecting flap nest.

More preferably, the first egg channel has a first conveying device, preferably a conveyor belt, for conveying eggs in the longitudinal direction of the row of nests. Particularly preferably, the second egg channel has a second conveying device, preferably a conveyor belt, for conveying eggs in the longitudinal direction of the row of nests.

In a further preferred embodiment, the first partial habitation area is configured as a slatted floor and/or has an inclination, preferably a uniform inclination, preferably downwards towards the row of nests. More preferably, the second partial habitation area is configured as a slatted floor and/or has an inclination, preferably a uniform inclination, preferably downwards towards the row of nests.

In accordance with a preferred embodiment, the first nest assembly has one, two, or a plurality of individual and/or family laying nests, and/or the second nest assembly has one, two, or a plurality of individual and/or family laying nests. More preferably, one, a plurality of, or all of the individual and/or family laying nests of the first nest assembly and/or of the second nest assembly is or are configured as a tilting floor nest and/or as a nest with our without an ejection device. Yet more preferably, one, a plurality of, or all of the individual and/or family laying nests of the first nest assembly and/or of the second nest assembly has or have a nest entrance which is raised with respect to the first or second partial habitation area.

A raised nest entrance has the advantage of making the nests more attractive to the poultry and/or have a positive effect on the wellbeing of the animal. Together with arranging the lower sections of the egg channels below the respective nest assemblies, in particular in the region below its access sides, it is more advantageous for the nest entrance located on the access side to be raised and to create space thereby below the nest assemblies for the lower sections of the egg channels.

A further preferred refinement is characterized by a plurality of first and a plurality of second nest assemblies which are respectively disposed in alternation in the longitudinal direction of the row of nests in succession and/or separated from one another. The housing system can therefore be scaled up readily.

Further advantageous variations of embodiments of the housing system described above will be produced by combining one, a plurality of, or all of the preferred features described herein.

In accordance with a further aspect of the invention, the aforementioned objective is achieved by a poultry house for holding poultry, in particular a house for laying hens, comprising a housing system as hereinbefore described.

In accordance with a further aspect of the invention, the aforementioned objective is achieved by means of a method for holding poultry, in particular laying hens, comprising: providing a housing system in a poultry house as hereinbefore described, in particular in a house for laying hens, collecting eggs in the first egg channel and/or in the second egg channel.

In particular, the method described above and its possible refinements have features or steps of the method which make it particularly suitable for use with a housing system and its further refinements as described hereinabove.

In accordance with a further aspect of the invention, the aforementioned objective is achieved by the use of a housing system as described hereinabove for holding poultry, in particular laying hens, in a poultry house, preferably in a poultry house as described hereinabove and/or in a method for holding poultry, in particular laying hens, preferably in a method as described hereinabove.

Regarding the advantages, preferred embodiments, and details of the individual aspects and their preferred embodiments, reference should also be made to the advantages, preferred embodiments, and details which have been described with reference to the respective other aspects.

Further advantageous embodiments will arise from a combination of individual, a plurality of, or all of the preferred features described herein.

### BRIEF DESCRIPTION OF THE DRAWINGS

Preferred exemplary embodiments shall now be described by way of example with the aid of the accompanying figures, in which:

FIG. 1 shows a diagrammatic three-dimensional representation of a housing system for poultry;

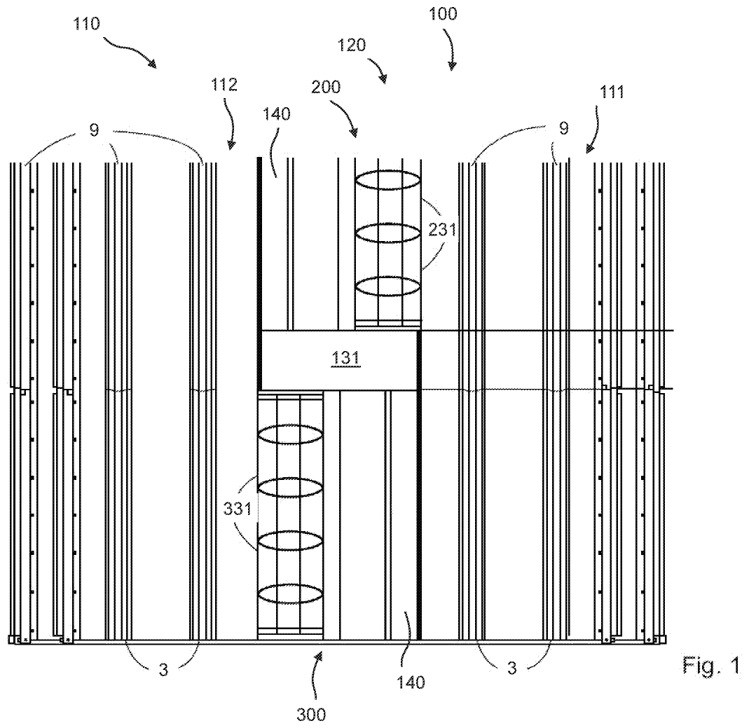

FIG. 2 shows a top view of the housing system of FIG. 1;

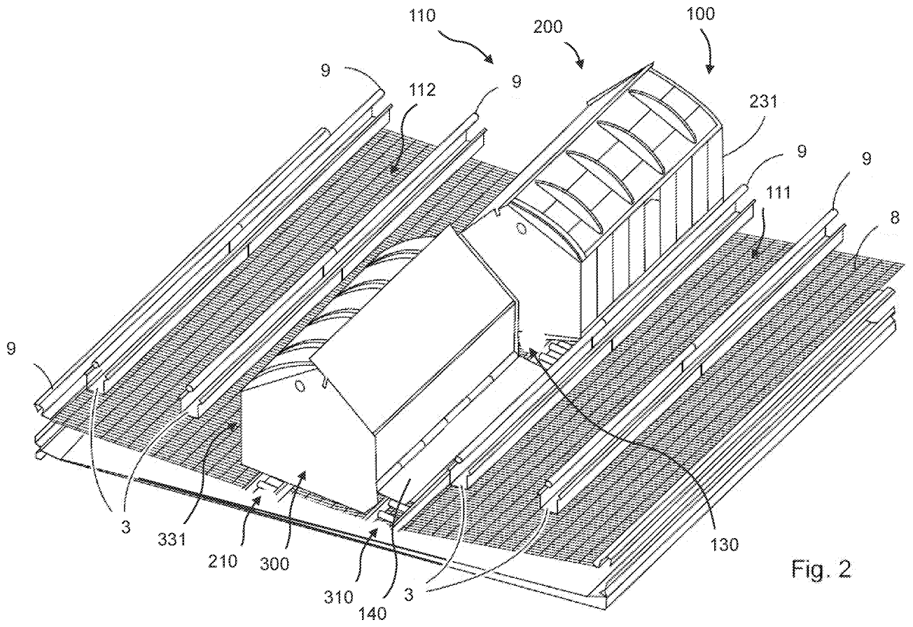

FIG. 3 shows a side view of the housing system of FIG. 1; and

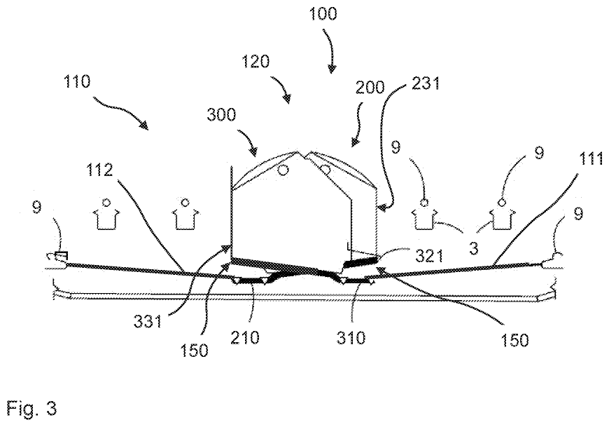

FIG. 4 shows a further side view of a housing system.

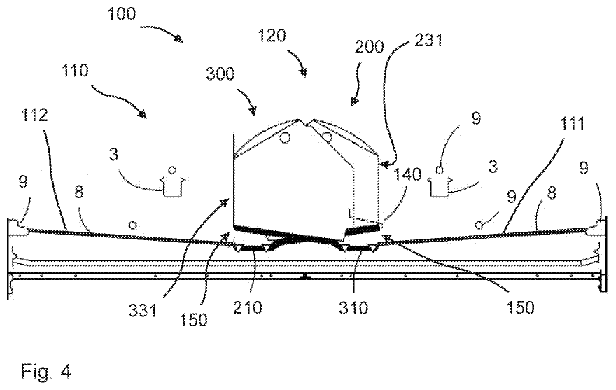

### DETAILED DESCRIPTION OF THE EMBODIMENTS

In the Figures, identical elements or elements with substantially identical functions are provided with the same reference numerals. As a rule, general descriptions refer to all embodiments unless differences are specifically described.

The Figures show a housing system 100 for poultry, in particular laying hens, in particular for poultry farming. The housing system 100 comprises an animal habitation area 110 which is divided into a first partial habitation area 111 and a second partial habitation area 112 by a centrally disposed row of nests 120. The two partial habitation areas 111, 112 are inclined towards the row of nests 120. Furthermore, both partial habitation areas 111, 112 have a downward inclination, which is identical in the example here, towards the row of nests 120.

Furthermore, both partial habitation areas 111, 112 are configured as slatted floors 8. A plurality of feeding devices 3 in the form of feed troughs as well as a plurality of perches 9 are disposed in the partial habitation areas 111, 112.

The row of nests 120 has a first nest assembly 200 and a second nest assembly 300. The first and second nest assemblies 200, 300 are disposed in succession in the longitudinal direction of the row of nests 120 and separated from each other by a passageway 130. The passageway 130 has a passageway cover 131 which is configured as a usable space for the poultry.

The passageway 130 between the two nest assemblies 200, 300 in particular serves for better accessibility to the nest assemblies 200, 300 and partial habitation areas 111, 112 both for the poultry and also for personnel. A cover for this passageway 130 is advantageous so that the eggs transported in the egg channels 210, 310 are also less soiled in this passageway region and do not become damaged. In addition, the passageway cover 131 is preferably configured as a usable space for the poultry. More advantageously, the passageway cover 131 is also configured to serve as a usable space for personnel.

The first and second nest assemblies 200, 300 preferably respectively have one, two, or a plurality of individual and/or family laying nests. One, a plurality of, or all of the individual and/or family laying nests may be configured as a tilting floor nest and/or as a nest with an ejection system such as an ejecting flap, for example, or may be configured entirely without an ejection system.

The first nest assembly 200 and the second nest assembly 300 are accessible to poultry from different access sides 231, 331, which in this example are opposite one another. The first access side 231 of the first nest assembly 200 faces the first partial habitation area 111. The second access side 332 of the second nest assembly 300 faces the second partial habitation area 112. In this manner, poultry can at any time seek out one of the nest assemblies 200, 300 from both the first and also from the second partial habitation area 111, 112.

Furthermore, one, a plurality of, or all of the individual and/or family laying nests of the first and second nest assemblies 200, 300 are preferably raised with respect to the first or second partial habitation area 111, 112, in particular at their respective nest entrance, which is preferably located at the respective access side 231, 331 of the nest assembly. This is particularly positive for the wellbeing of the animals, and also has a positive effect on the quality of the eggs and increases the attraction of the nests.

Furthermore, the floor of the first and second nest assemblies 200, 300 are inclined, preferably uniformly, from the respective access side 231, 331 downwards to the respectively opposite rear side. In this manner, it is possible for the eggs laid in the nest assembly 200, 300 to roll away towards the respective rear, i.e., away from the respective access side 231, 331 and from there to reach the respective egg channel 210, 310.

The first nest assembly 200 has a first egg channel 210 which is disposed between the first nest assembly 200 and the second partial habitation area 112. The first egg channel 210 therefore faces away from the access side 231 of the first nest assembly 200 and is disposed in the region of the rear side of the first nest assembly 200 at the edge of the row of nests 120 adjoining the second partial habitation area 112.

The second nest assembly 300 has a second egg channel 310 which is disposed between the second nest assembly 300 and the first partial habitation area 111. The second egg channel 310 therefore faces away from the access side 331 of the second nest assembly 300 and is disposed in the region of the rear side of the second nest assembly 300 at the edge of the row of nests 120 adjoining the first partial habitation area 111.

Furthermore, the first and the second egg channels 200, 300 run parallel to each other and parallel to the longitudinal direction of the row of nests 120.

The configuration of the first egg channel will now be described in more detail. The same applies, mutatis mutandis, for the configuration of the second egg channel.

The first egg channel 210 preferably extends over the entire length of the housing system 100 and has different sections.

In a cover section, which preferably runs along the extent of the first nest assembly 200, the first egg channel 210 is disposed below and slightly inwardly so that the cover section is partially covered by the first nest assembly 200 and partially covered by the cover floor 321.

The first egg channel 210 also runs continuously between the first nest assembly 200 and the second nest assembly 300 in a passageway section which is preferably covered by a passageway cover.

The first egg channel 210 then runs in a lower section below the second nest assembly 300, preferably below the access side 331 or below the nest entrance for the second nest assembly 300 and under this second nest assembly 300. In this manner, a separate cover for the first egg channel 210 in the lower section can be dispensed with because this first egg channel 210 runs under the second nest assembly 300. In this manner, in addition, the available area has a twofold function: the upper nest and the egg channel below it.

In this lower section, the first egg channel 210 is preferably not accessible to eggs from the nest assemblies. Furthermore, preferably, an egg receiving gap 150 is provided between the first egg channel 210 and the second nest assembly 300, in particular its nest entrance, through which the eggs laid in the second partial habitation area 112 (also termed system eggs) can reach the first egg channel 210, in particular by rolling off.

The first nest assembly 200 is preferably configured such that eggs laid in the first nest assembly 200, preferably in a back region adjoining the rear side, can reach the first egg channel 210. To this end, this first egg channel 210 may be wholly or partially below the first nest assembly 200 and/or adjoining it and/or be adjacent to it. However, the first egg channel 210 may also be partially or completely covered by a cover, in particular in the form of a cover floor 140, wherein the cover floor 140 is preferably attached to the rear side of the first nest assembly 200. In this manner, soiling and/or damage to the eggs is prevented or at least reduced in this section too.

This housing system 100 for poultry, in particular laying hens, in particular for poultry farming, with two centrally disposed nest assemblies 200, 300 as well as two separate egg channels for this nest assembly, which in sections runs entirely or partially below the nest assemblies 200, 300, provides a particularly simple and space-saving solution.

1.-14. (canceled)

15. A housing system for poultry comprising:
an animal habitation area divided into a first partial habitation area and a second partial habitation area by a centrally disposed row of nests;
wherein the centrally disposed row of nests comprises a first nest assembly with a first egg channel and a second nest assembly with a second egg channel.

16. The housing system as claimed in claim 15, wherein:
the first egg channel is disposed between the first nest assembly and the second partial habitation area;
the second egg channel is disposed between the second nest assembly and the first partial habitation area; and
the first egg channel and the second egg channel run parallel to each other and/or parallel to the longitudinal direction of the centrally disposed row of nests.

17. The housing system as claimed in claim 15, further comprising:
a first cover section of the first egg channel that is provided with a first cover, wherein the first cover is partly formed by the first nest assembly and partly formed by a first cover floor, and wherein the first cover floor is configured to serve as a usable space for the poultry; and/or
a second cover section of the second egg channel that is provided with a second cover, wherein the second cover is partly formed by the second nest assembly and partly formed by a second cover floor, and wherein the second cover floor is configured so as to serve as a usable space for the poultry.

18. The housing system as claimed in claim 15, wherein:
a lower section of the first egg channel runs wholly or partially below the second nest assembly; and/or
a lower section of the second egg channel runs wholly or partially below the first nest assembly.

19. The housing system as claimed in claim 15, wherein:
the first nest assembly and the second nest assembly are accessible to poultry from opposite access sides; and
the access side for the first nest assembly faces the first partial habitation area and the access side for the second nest assembly faces the second partial habitation area.

20. The housing system as claimed in claim 15, wherein in the longitudinal direction of the centrally disposed row of nests, the first nest assembly and the second nest assembly are disposed in succession and/or are separated from one another by a passageway.

21. The housing system as claimed in claim 20, wherein the passageway has a passageway cover for covering for a passageway section of the first egg channel and/or of the second egg channel, and wherein the passageway cover is configured to serve as a usable space for the poultry.

22. The housing system as claimed in claim 15, wherein:
the first partial habitation area is inclined towards the centrally disposed row of nests;
the first partial habitation area has one or more feeding devices, one or more drinkers, and/or one or more perches;
the second partial habitation area is inclined towards the centrally disposed row of nests; and/or
the second partial habitation area has one or more feeding devices, one or more drinkers, and/or one or more perches.

23. The housing system as claimed in claim 15, wherein:
the first egg channel is disposed to receive eggs from the first nest assembly and/or from the second partial habitation area through a first egg receiving gap;
the first egg channel is disposed below a lower end of the first partial habitation area and/or below a lower end of the second partial habitation area;
the first egg channel comprises a first conveying device for conveying eggs in the longitudinal direction of the centrally disposed row of nests;
the second egg channel is disposed to receive eggs from the second nest assembly and/or from the first partial habitation area through a second egg receiving gap;
the second egg channel is disposed below a lower end of the first partial habitation area and/or below a lower end of the second partial habitation area; and/or
the second egg channel comprises a second conveying device for conveying eggs in the longitudinal direction of the centrally disposed row of nests.

24. The housing system as claimed in claim 23, wherein the first and second conveying device each comprise a conveyor belt.

25. The housing system as claimed in claim 15, wherein the first partial habitation area is configured as a slatted floor and/or has an inclination downwards towards the centrally disposed row of nests; and/or
wherein the second partial habitation area is configured as a slatted floor and/or has an inclination downwards towards the centrally disposed row of nests.

26. The housing system as claimed in claim 25, wherein the inclination of the first partial habitation area and the second partial habitation area is configured as a uniform inclination.

27. The housing system as claimed in claim 15, wherein:
the first nest assembly has one, two, or a plurality of individual or family laying nests;
the second nest assembly has one, two or a plurality of individual or family laying nests;
a one, a plurality of, or all of the individual or family laying nests of the first nest assembly or of the second nest assembly is or are configured as a tilting floor nest or as a nest with or without an ejection device; and/or
a one, a plurality of, or all of the individual or family laying nests of the first nest assembly or of the second nest assembly has or have a nest entrance which is raised with respect to the first or second partial habitation area.

28. The housing system as claimed in claim 15, further including a plurality of first nest assemblies and a plurality of second nest assemblies which are respectively disposed in alternation in the longitudinal direction of the centrally disposed row of nests in succession and/or separated from one another.

29. A poultry house for holding poultry comprising a housing system as claimed in claim 15.

30. A method for holding poultry comprising the steps of:
providing a housing system in accordance with claim 15 in a poultry house; and
collecting eggs in the first egg channel and/or in the second egg channel.

31. Use of a housing system as claimed in claim 15 for holding poultry.

32. A poultry housing for holding poultry comprising:
an animal habitation area divided into a first partial habitation area and a second partial habitation area;
a centrally disposed row of nests dividing the first partial habitation area and the second partial habitation area, the centrally disposed row of nests comprising a first nest assembly and a second nest assembly;
a first egg channel disposed between the first nest assembly and the second partial habitation area; and
a second egg channel disposed between the second nest assembly and the first partial habitation area.

33. The poultry housing for holding poultry of claim 32, wherein:
in the longitudinal direction of the centrally disposed row of nests, the first nest assembly and the second nest assembly are disposed in succession and/or are separated from one another by a passageway; and
the first egg channel and the second egg channel run parallel to each other and/or parallel to the longitudinal direction of the centrally disposed row of nests.

34. A poultry housing for holding poultry comprising:
an animal habitation area divided into a first partial habitation area and a second partial habitation area; and
a centrally disposed row of nests dividing the first partial habitation area and the second partial habitation area, the centrally disposed row of nests comprising a first nest assembly and a second nest assembly;
a first egg channel disposed between the first nest assembly and the second partial habitation area; and
a second egg channel disposed between the second nest assembly and the first partial habitation area;
wherein the first nest assembly and the second nest assembly are accessible to poultry from opposite access sides, and the access side for the first nest assembly faces the first partial habitation area and the access side for the second nest assembly faces the second partial habitation area.
